(19) United States
(12) Patent Application Publication
(10) Pub. No.: US 2008/0007576 A1
(43) Pub. Date: Jan. 10, 2008

(54) Image display device with gray scales controlled by oscillating and positioning states

(76) Inventors: Fusao Ishii, Menlo Park, CA (US); Yoshihiro Maeda, Tokyo (JP); Hirotoshi Ichikawa, Tokyo (JP); Kazuma Arai, Tokyo (JP)

Correspondence Address: Bo-In Lin, 13445 Mandoli Drive, Los Altos Hills, CA, 94022, US

(21) Appl. No.: 11/823,942

(22) Filed: Jun. 29, 2007

Related U.S. Application Data
(63) Continuation-in-part of application No. 11/121,543, filed on May 4, 2005, now Pat. No. 7,268,932.
Application No. 11/121,543 is a continuation-in-part of application No. 10/698,620, filed on Nov. 1, 2003.
Application No. 11/121,543 is a continuation-in-part of application No. 10/699,140, filed on Nov. 1, 2003, now Pat. No. 6,862,127.
Application No. 11/121,543 is a continuation-in-part of application No. 10/699,143, filed on Nov. 1, 2003, now Pat. No. 6,903,860.
(60) Provisional application No. 60/818,119, filed on Jun. 30, 2006.

(51) Int. Cl. G09G 5/10

(52) U.S. Cl. 345/691

(57) ABSTRACT

An image display device, which uses a spatial light modulator (SLM), comprises a deflective modulation element, which is provided in the SLM, for deflecting illuminating light depending on the deflection state of the element itself, a data converting unit for converting at least N consecutive bits of binary data according to an image signal into non-binary data, and a controlling unit for controlling the deflective modulation element with the non-binary data.

This application is a Non-provisional Application of a Provisional Application 60/818,119 filed on Jun. 30, 2006. The Provisional Application 60/818,119 is a Continuation in Part (CIP) Application of a pending U.S. patent application Ser. No. 11/121,543 filed on May 4, 2005. The application 11/121,543 is a Continuation in part (CIP) Application of three previously filed applications. These three applications are Ser. No. 10/698,620 filed on Nov. 1, 2003, Ser. No. 10/699,140 filed on Nov. 1, 2003, and Ser. No. 10/699,143 filed on Nov. 1, 2003 by one of the Applicants of this patent application. The disclosures made in these patent applications are hereby incorporated by reference in this patent application.

### TECHNICAL FIELD

This invention relates to image display device. More particularly, this invention relates to display device with an image data translating a part of or all of binary image signals into non-binary data. Background Art Even though there are significant advances made in recent years on the technologies of implementing electromechanical micromirror devices as spatial light modulator (SLM), there are still limitations and difficulties when employed to provide high quality images display. Specifically, when the display images are digitally controlled, the image qualities are adversely affected due to the fact that the image is not displayed with sufficient number of gray scales.

Electromechanical micromirror devices have drawn considerable interest because of their application as spatial light modulators (SLMs). A spatial light modulator requires an array of a relatively large number of micromirror devices. In general, the number of devices required ranges from 60,000 to several million for each SLM. Referring to FIG. 1A for a digital video system 1 disclosed in a relevant U.S. Pat. No. 5,214,420 that includes a display screen 2. A light source 10 is used to generate light energy for ultimate illumination of display screen 2. Light 9 generated is further concentrated and directed toward lens 12 by mirror 11. Lens 12, 13 and 14 form a beam columnator to operative to columnate light 9 into a column of light 8. A spatial light modulator 15 is controlled by a computer 19 through data transmitted over data cable 18 to selectively redirect a portion of the light from path 7 toward lens 5 to display on screen 2. The SLM 15 has a surface 16 that includes an array of switchable reflective elements, e.g., micromirror devices 32, such as elements 17, 27, 37, and 47 as reflective elements attached to a hinge 30 that shown in FIG. 1B. When element 17 is in one position, a portion of the light from path 7 is redirected along path 6 to lens 5 where it is enlarged or spread along path 4 to impinge the display screen 2 so as to form an illuminated pixel 3. When element 17 is in another position, light is not redirected toward display screen 2 and hence pixel 3 would be dark.

The on-and-off states of micromirror control scheme as that implemented in the U.S. Pat. No. 5,214,420 and by most of the conventional display system imposes a limitation on the quality of the display. Specifically, when applying conventional configuration of control circuit has a limitation that the gray scale of conventional system (PWM between ON and OFF states) is limited by the LSB (least significant bit, or the least pulse width). Due to the On-Off states implemented in the conventional systems, there is no way to provide shorter pulse width than LSB. The least brightness, which determines gray scale, is the light reflected during the least pulse width. The limited gray scales lead to degradations of image display.

Specifically, FIG. 1C shows an exemplary circuit diagram of a prior art control circuit for a micromirror according to U.S. Pat. No. 5,285,407. The control circuit includes memory cell 32. Various transistors are referred to as “M*” where * designates a transistor number and each transistor is an insulated gate field effect transistor. Transistors M5, and M7 are p-channel transistors; transistors, M6, M8, and M9 are n-channel transistors. The capacitances, C1 and C2, represent the capacitive loads presented to the memory cell 32. Memory cell 32 includes an access switch transistor M9 and a latch 32a based on a static random access switch memory (SRAM) design. All access transistors M9 are arranged in a row and each transistor receives a DATA signal from a different bit-line. The particular memory cell 32 to be written is accessed by turning on the appropriate row select transistor M9, using the ROW signal functioning as a word-line. Latch 32a is formed with two cross-coupled inverters, M5/M6 and M7/M8 to operate with two stable states, i.e., State 1 is Node A high and Node B low and state 2 is Node A low and Node B high.

The dual states switching as illustrated by the control circuit controls the micromirrors to position either at an ON or an OFF angular orientation as that shown in FIG. 1A. The brightness, i.e., the gray scales of display for a digitally control image system is determined by the length of time the micromirror stays at an ON position. The length of time a micromirror is controlled at an ON position is in turned controlled by a multiple bit word. For simplicity of illustration, FIG. 1D shows the “binary time intervals” when control by a four-bit word. As that shown in FIG. 1D, the time durations have relative values of 1, 2, 4, 8 that in turn define the relative brightness for each of the four bits where 1 is for the least significant bit and 8 is for the most significant bit. According to the control mechanism as shown, the minimum controllable differences between gray scales for showing different brightness is a brightness represented by a “least significant bit” that maintaining the micromirror at an ON position.

When adjacent image pixels are shown with great degree of different gray scales due to a very coarse scale of controllable gray scale, artifacts are shown between these adjacent image pixels. That leads to image degradations. The image degradations are specially pronounced in bright areas of display when there are “bigger gaps” of gray scales between adjacent image pixels. It was observed in an image of a female model that there were artifacts shown on the forehead, the sides of the nose and the upper arm. The artifacts are generated due to a technical limitation that the digital controlled display does not provide sufficient gray scales. At the bright spots of display, e.g., the forehead, the sides of the nose and the upper arm, the adjacent pixels are displayed with visible gaps of light intensities.

As the micromirrors are controlled to have a fully on and fully off positions, the light intensity is determined by the length of time the micromirror is at the fully on position. In order to increase the number of gray scales of display, the speed of the micromirror must be increased such that the digital control signals can be increased to a higher number of bits. However, when the speed of the micromirrors is increased, a strong hinge is necessary for the micromirror to sustain a required number of operational cycles for a designated lifetime of operation, In order to drive the micromirrors supported on a further strengthened hinge, a higher voltage is required. The higher voltage may exceed twenty volts and may even be as high as thirty volts. The micromirrors manufacture by applying the CMOS technologies probably would not be suitable for operation at such higher range of voltages and therefore the DMOS micromirror devices may be required. In order to achieve higher degree of gray scale control, a more complicate manufacturing process and larger device areas are necessary when DMOS micromirror is implemented. Conventional modes of micromirror control are therefore facing a technical challenge that the gray scale accuracy has to be sacrificed for the benefits of smaller and more cost effective micromirror display due to the operational voltage limitations.

There are many patents related to light intensity control. These Patents include U.S. Pat. Nos. 5,589,852, 6,232,963, 6,592,227, 6,648,476, and 6,819,064. There are further patents and patent applications related to different shapes of light sources. These Patents includes U.S. Pat. Nos. 5,442,414, 6,036,318 and Application 20030147052. The U.S. Pat. No. 6,746,123 discloses special polarized light sources for preventing light loss. However, these patents and patent application do not provide an effective solution to overcome the limitations caused by insufficient gray scales in the digitally controlled image display systems.

Furthermore, there are many patents related to spatial light modulation that includes U.S. Pat. Nos. 20,25,143, 2,682,010, 2,681,423, 4,087,810, 4,292,732, 4,405,209, 4,454,541, 4,592,628, 4,615,595, 4,728,185, 4,767,192, 4,842,396, 4,907,862, 5,214,420, 5,287,096, 5,506,597, 5,489,952, 6064,366, 6535,319, and 6,880,936. However, these inventions have not addressed and provided direct resolutions for a person of ordinary skill in the art to overcome the above-discussed limitations and difficulties.

Therefore, a need still exists in the art of image display systems applying digital control of a micromirror array as a spatial light modulator to provide new and improved systems such that the above-discussed difficulties can be resolved.

### SUMMARY OF THE INVENTION

A preferred embodiment of the present invention is an image display device using a spatial light modulator (SLM), and comprises illuminating light incident to a deflective modulation element provided in the SLM, the deflective modulation element for deflecting the illuminating light depending on the deflection state of the element itself, binary data according to an image signal, a data converting unit for converting at least N consecutive bits of the binary data into non-binary data, and a controlling unit for controlling the deflective modulation element with the non-binary data.

These and other objects and advantages of the present invention will no doubt become obvious to those of ordinary skill in the art after having read the following detailed description of the preferred embodiment, which is illustrated in the various drawing figures.

### BRIEF DESCRIPTION OF FIGURES

The present invention is described in detail below with reference to the following Figures.

FIGS. 1A and 1B are functional block diagram and a top view of a portion of a micromirror array implemented as a spatial light modulator for a digital video display system of a conventional display system disclosed in a prior art patent.

FIG. 1C is a circuit diagram for showing a prior art circuit for controlling a micromirror to position at an ON or OFF states of a spatial light modulator.

FIG. 1D is diagram for showing the binary time intervals for a four bit gray scale.

FIG. 2A shows a prior art scheme and FIGS. 2B and 2C shows an intermediate state control of this invention.

FIG. 3A shows a control system using non-binary data, and FIG. 3B is a cross-sectional view showing one example of each of deflective modulation elements arranged in an SLM in the form of an array.

FIG. 4A shows a prior art scheme and FIGS. 4B and 4C show the PWM control system using non-binary data of this invention.

FIG. 5 shows a control block diagram for illustrating a method to control illumination of this invention.

FIG. 6A shows a functional block diagram of a SLM and FIG. 6B shows a control circuit diagram that executes a Digital Signal Control scheme.

FIGS. 7A and 7B show the data and corresponding display states of another preferred embodiment with the N bits as the number of difference between the number of bits of incoming image signal and the number of bits to display in gray scale.

FIG. 8A shows a pulse width diagram of a control signal for a SLM with corresponding light intensity in a frame period and FIG. 8B shows a control circuit diagram that implements an illuminating light is from semiconductor laser source or LED light source.

FIGS. 9 to 12 show the circuit diagrams of different control circuit diagrams for carrying out different gray scale control schemes as embodiments of this invention.

FIG. 13 shows an optical configuration example of a single-panel image display device according to a preferred embodiment of the present invention.

FIGS. 14A, 14B, and 14C show an optical configuration example of a two-panel image display device according to a preferred embodiment of the present invention.

FIG. 15 shows an optical configuration example of a three-panel image display device according to a preferred embodiment of the present invention.

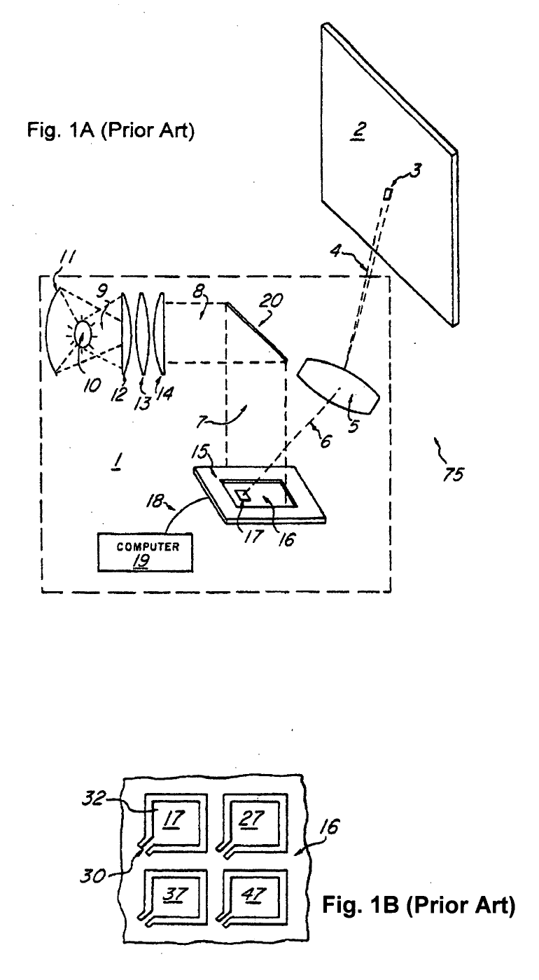

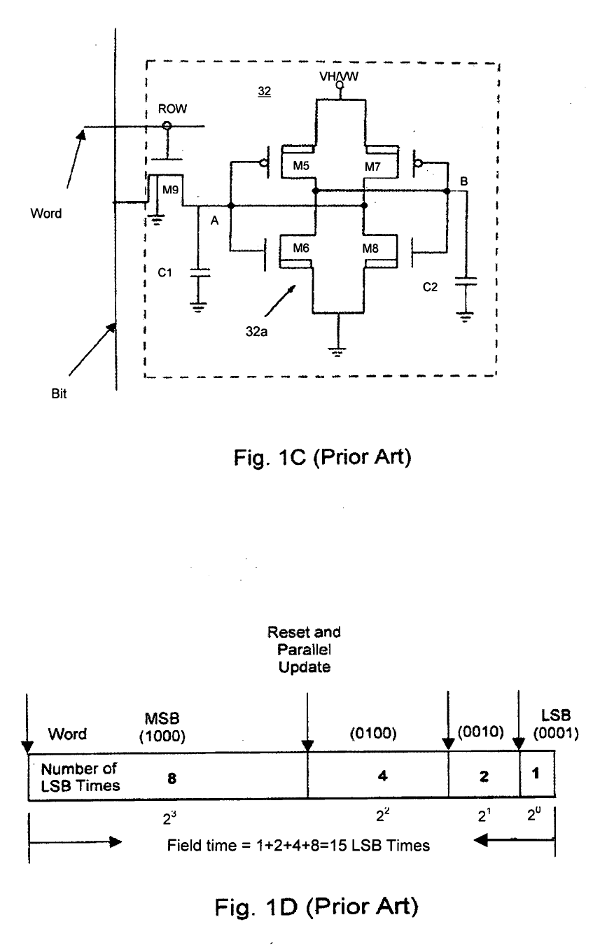

### DESCRIPTION OF PREFERRED EMBODIMENTS

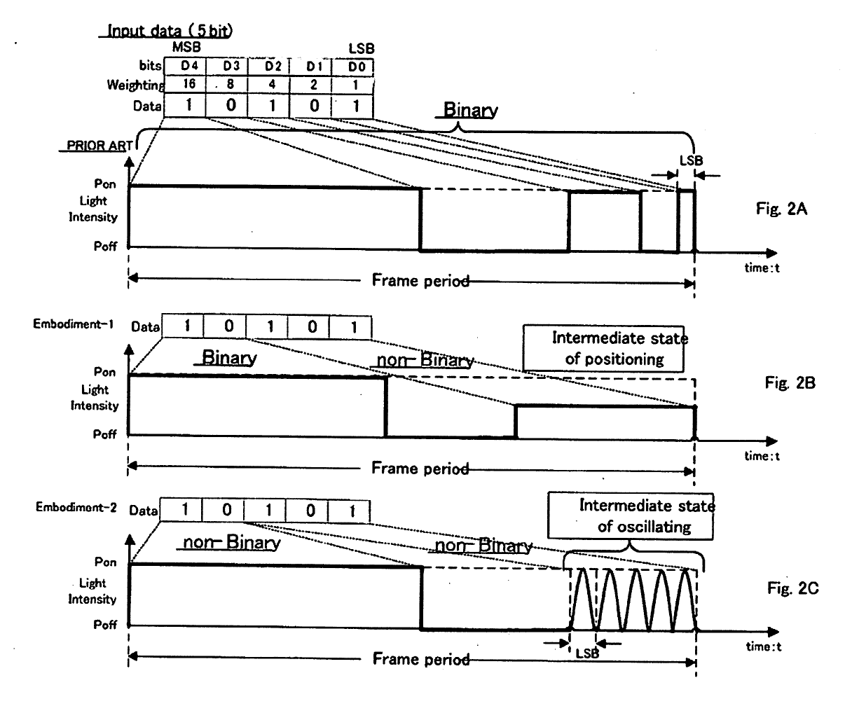

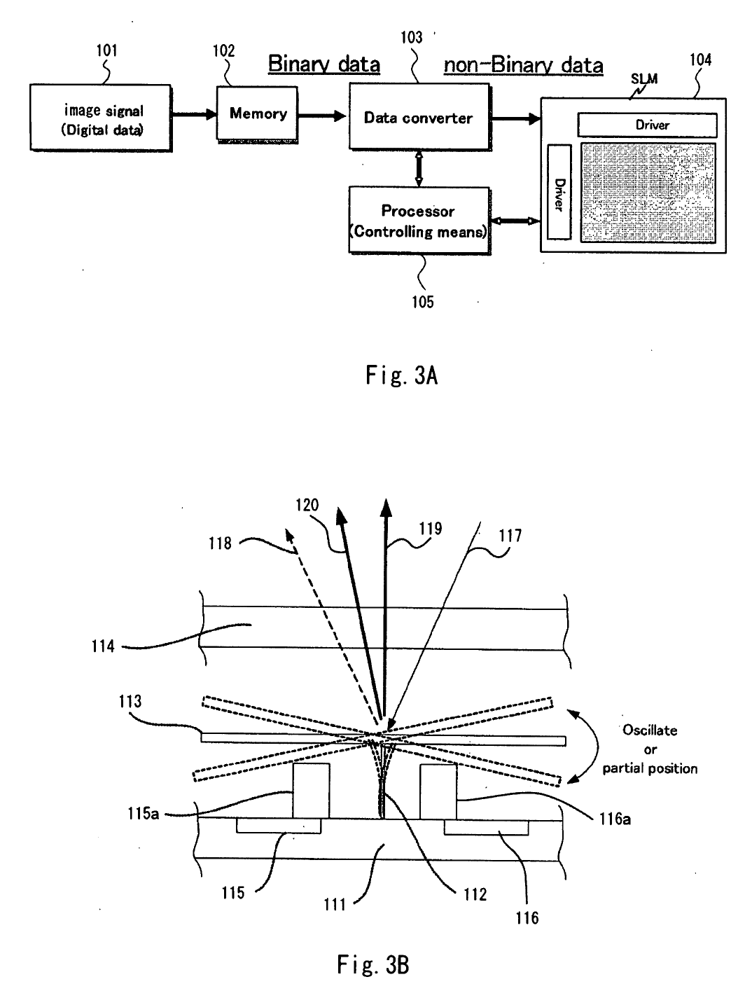

Referring to FIG. 2A for a prior art scheme with input data of five bits as binary data of either zero or one as that represented by D0 to D4 wherein D0 is the least significant bit having a weighting factor of one and D4 is the most significant bit (MSB) having a weighting factor of 16 to control the frame period. In contrast, FIGS. 2B and 2C are diagrams for showing two embodiments of this invention that include a data converter as that shown in FIG. 3A below, to convert a binary input data into non-binary data to control the oscillation or positioning of the mirrors in a SLM to further increase the gray scales of an image display device. The non-binary data is applied as shown in FIG. 2B to control the mirrors to have an intermediate state of positioning, and in FIG. 2C, the non-binary data is applied to control the mirrors to have an intermediate state of oscillation. The image display device as will be further discussed below therefore includes a controller to receive non-binary data to carry out an oscillation control or a positioning control of the micromirrors in a SLM.

An image display device according to a preferred embodiment of the present invention is an image display device using a spatial light modulator (SLM), and comprises a light source for projecting an illuminating light incident to a deflective modulation element of the SLM. The deflective modulation element is employed to deflect the illuminating light depending on a deflection state of the deflective modulation element and the state of the deflective modulation element is controlled by a binary data according to an image signal. The image display device further includes a data-converting unit for converting at least N consecutive bits of the binary data into non-binary data. The image display device further includes a controlling unit for controlling the deflective modulation element with the non-binary data.

With the image display device having such a configuration, a light with a reduced intensity can be projected for the state of a fully ON direction. The fully ON state is a stationary deflection state. The micromirrors can be controlled to move by the deflective modulation element according to an oscillating state or a state of a stationary intermediate direction. Additionally, more flexible intermediate state can be achieved by applying non-binary data to the oscillating state. Therefore, a display of higher gray scales that does not depend only on the deflection angle of the micromirrors is achievable.

FIG. 2A is a diagram for illustrating one frame period for projection a display light in a conventional image display device. A SLM is implemented that includes a deflective modulation element for deflecting illuminating light depending on the state of a stationary deflection direction either as a fully ON direction or a fully OFF direction. FIG. 2A illustrates that the display light projection in one frame period is controlled according to the state of the deflection direction of the deflective modulation element. The length of time the mirror stays at a fully ON direction or a fully OFF direction is depending on the values of bits from LSB to MSB in binary data. The binary data is input data and then weighting factors pre-assigned to the bits from LSB to MSB are applied to each bit for controlling the lengths of time as shown in FIG. 2A. Therefore, the intensity of the projected light for displaying the image is conventionally controlled by binary data according to the input data, and the input data is directly without changes.

FIG. 2B is a timing diagram for showing a control of the light intensity in one frame period in an image display device according to a preferred embodiment of the present invention. The display device implements an SLM that includes a deflective modulation element for defecting illuminating light depending on the state of a stationary deflection direction such as a fully ON direction, a fully OFF direction, or an intermediate direction. The intermediate direction may be a stationary direction between the fully ON direction and the fully OFF direction. The state of the stationary deflection direction when the modulation element is inclined along the intermediate direction is referred to as an intermediate state. As shown in FIG. 2B, with the image display device according to this preferred embodiment, at least N consecutive bits of binary data, which is input data, is converted into non-binary data, and the remaining bits are left unchanged as binary data. In the example shown in FIG. 2B, the lowest-order 3 bits of binary data, which is input data, are converted into non-binary data, and the remaining highest-order 2 bits are left unchanged as binary data. The state of the deflection direction of the deflective modulation element is controlled to operate as the state of the fully ON direction or the fully OFF direction according to the values of the bits left unchanged and the binary data with the weighting factors pre-assigned to these bits. The deflective modulation element is controlled to operate as the state of a continuing intermediate direction according to the converted non-binary data, whereby projected light in one frame period is controlled. In this preferred embodiment, the projected light for image display is controlled by converting part of the input binary data into non-binary data and by applying the non-binary data and the remaining binary data to more flexibly adjust the gray scales of image display.

FIG. 2C is another diagram for showing the control scheme in one frame period in an image display device according to a preferred embodiment of the present invention. The display system includes a SLM that has a deflective modulation element for deflecting illuminating light depending on the state of a stationary deflection direction. The state of the deflection direction includes a fully ON direction or a fully OFF direction, and also an oscillating state. Here, the oscillating state is a state where the deflection direction varies with time. The deflection direction in an oscillating state is between the fully ON direction and the fully OFF direction. The oscillating state is referred to also as an intermediate state. As shown in FIG. 2C, in the image display device receives input binary data and converts the input binary data into non-binary data. Then, the state of the deflection direction of the deflective modulation element is controlled to operate with a state of the fully ON direction or a fully OFF direction, or an oscillating state according to the converted non-binary data, whereby projected light in one frame period is controlled. More specifically, the state of the deflection direction of the deflective modulation element is controlled to operate at the state of a continuing fully ON direction or fully OFF direction, and also by using non-binary data converted from consecutive binary data to operate at a continuing oscillating state. Specifically, in this preferred embodiment, the projected light for display is controlled by first converting the input binary data into non-binary data and then applies the non-binary data to control the deflective element.

Alternate embodiments of this invention further include a replacement of the intermediate state of FIG. 2B with the control sequences of the oscillating state shown in FIG. 2C, or conversely replacing the intermediate state of FIG. 2C with the control sequences of the state of the intermediate direction shown in FIG. 2B.

Referring to FIG. 3A for a functional block diagram to illustrate a control system. The image signal 101 is received into the controller as digital data and stored into a memory 102. The digital image data is then read into a data converter 103 to convert a part of or all of the digital image data into non-binary data for inputting to a spatial light modulator (SLM) 104 with drivers to receive the signal to control the deflective micromirrors. The controller further includes a controlling processor 105 for controlling the data converter 103 and the SLM 104. Referring to FIG. 3B for the mirror control process in the SLM 104 controlled with the non-binary data generated from the data converter 103 of FIG. 3A.

The above described image display device according to the preferred embodiment of the present invention further discloses a method for controlling the image display device that includes a step of projecting a light for deflection by a deflective modulation element. The deflection element has a cross-section of a non-uniform intensity distribution whereby a gray scale of display can be controlled by adjusting the deflection state of the deflective modulation element.

With the image display device having such a configuration, the projected light has a cross-section of a non-uniform intensity distribution. The reduced light intensity in non-uniform light distribution is further applied to generate an image display with a higher level of gray scales.

FIG. 3A shows a system configuration example of an image display device according to a preferred embodiment of the present invention. In FIG. 3A, a data converter 103 converts at least N consecutive bits of binary data into non-binary data under the control of a processor 105. An SLM 104 drives a deflective modulation element under the control of the processor 105 according to non-binary data converted from part of the binary data by the data converter 103 and the remaining binary data, or according to non-binary data converted from entire binary data by the data converter 103 as described above. In this way, the SLM 104 can perform, for example, the control shown in FIG. 2B or that shown in FIG. 2C.

FIG. 3B is a cross-sectional view showing an example of each of deflective modulation elements arranged in the SLM 104 in the form of a two-dimensional array. FIG. 3B shows a mirror element that functions as a deflective modulation element. The mirror element comprises a mirror 113 supported on a hinge 112 that is further supported on a substrate 111 to freely tilt to different angular positions. A glass layer 114 covers and protects the mirror 113. The mirror element further includes an OFF electrode 115, an OFF stopper 115a, an ON electrode 116, and an ON stopper 116a on the substrate 111 and arranged at positions symmetrically with respect to the hinge 112.

A signal to the OFF electrode 115 tilts the mirror 113 to a position that causes the mirror 113 contacts the OFF stopper 115a by drawing the mirror 113 with coulomb force when the signal applying a predetermined potential to the electrode 115. Consequently, incident light 117 incident to the mirror 113 is reflected onto the light path 118 of the OFF position. The reflected light deviates from the optical axis of the projection optical system. The deflection state of the mirror element at this time is referred to as a fully OFF state or simply as an OFF state.

A signal to the ON electrode 116 tilts the mirror 113 to a position that causes the mirror 113 contacts the ON stopper 116a by drawing the mirror 113 with coulomb force when the signal applying a predetermined potential to the ON electrode 116. Consequently, the incident light 117 incident to the mirror 113 is reflected on the light path 119 of the ON position. The reflected light is projected along an optical path aligned with the optical axis of the projection optical system. The deflection state of the mirror element at this time is referred to as a fully ON state or merely as an ON state.

Additionally, the OFF electrode 115 or the ON electrode 116 causes the mirror 113 to start free oscillation with the elasticity of the hinge 112 by stopping the application of a predetermined potential when being applied. As a result, the incident light 117 incident to the mirror 113 is reflected on a light path (for example, a light path 120 at one time), which varies with time between the light path 118 of the OFF position and the light path 119 of the ON position. The deflection state of the mirror element at this time is referred to as an oscillating state.

Furthermore, an electric signal applied to the OFF electrode 115 and the ON electrode 116 causes the mirror 113 to tilt to a position before contacting the OFF stopper 115a by drawing the mirror 113 with coulomb force as a result of respectively applying a first potential and a second potential lower than the first potential to the OFF electrode 115 and the ON electrode 116. Since Coulomb force is exerted also between the mirror 113 and the ON electrode 116 at this time, the mirror 113 stops in a position before the OFF stopper 115a without contacting the OFF stopper 115a. As a result, the incident light 117 incident to the mirror 113 is reflected on a stationary light path (for example, the light path 120) between the light path 118 of the OFF position and the light path 119 of the ON position. The deflection state of the mirror element at this time is referred to as a state of an intermediate direction.

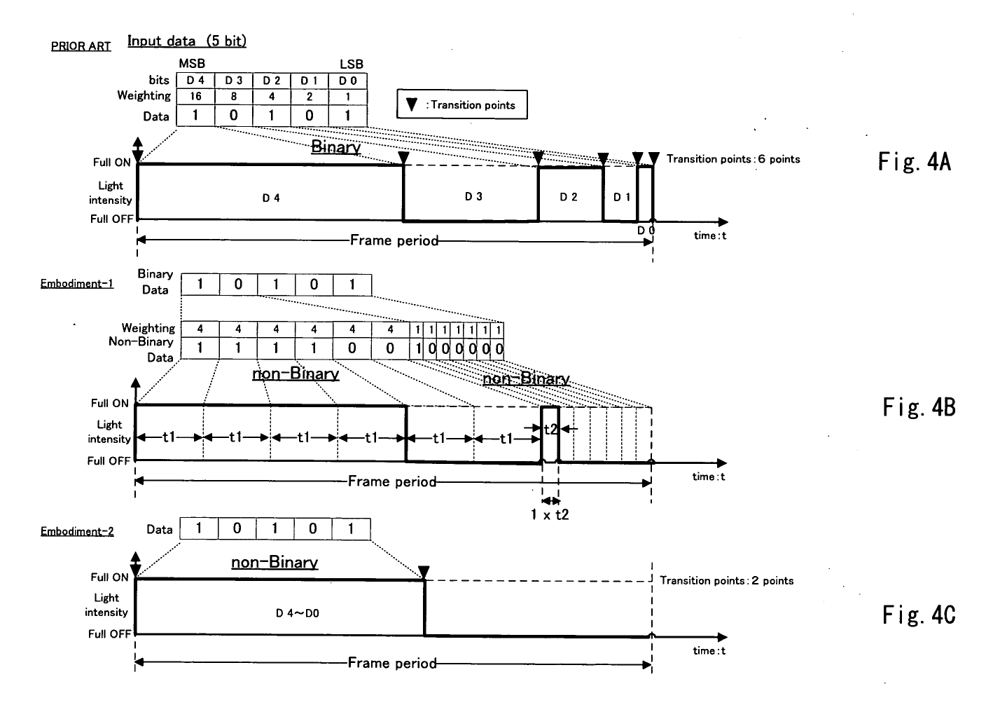

Referring to FIG. 4A for a prior art scheme and also to FIGS. 4B and 4C for PWM control system using non-binary data. When a PWM control is performed by using the non-binary data, an image display device according to a preferred embodiment of the present invention is configured as follows. Specifically, the image display device using a spatial light modulator (SLM) comprises a light source for projecting an illuminating light incident to a deflective modulation element of a SLM.

The deflective modulation element deflects the illuminating light depending on at least two deflection states of the deflective element. The image display system receives input binary data according to an image signal. The image display system further includes a data-converting unit for converting at least N consecutive bits of the binary data into non-binary data. And the image display system further includes a controlling unit for controlling the deflective modulation element with the non-binary data, wherein the controlling unit controls the deflective modulation element so that the deflection state of the deflective modulation element is maintained continuously.

With the image display device having such a configuration, the following effects can be expected also when the non-binary data is applied to the state of a stationary deflection direction of the deflective modulation element.

1) An image display can be made by using sub-frames having the same display time, whereby a time load on the controlling unit can be made uniform (see FIGS. 4B and 4C).

2) A desired gray scale can be achieved in one or more continuing deflection states of the deflective modulation element, whereby the number of times of deflection state switching, which can cause an error of a gray scale display, can be reduced or made uniform. Accordingly, the accuracy of gray scale display can be improved (see FIGS. 4B and 4C).

FIG. 4A shows an example of PWM control performed with binary data in one frame period in a conventional image display device using an SLM. The SLM includes a deflective modulation element for deflecting illuminating light depending on the state of a stationary deflection direction such as a fully ON direction or a fully OFF direction, and also shows an example of control of the projected light shown in FIG. 2A. As shown in FIG. 4A, with the conventional image display device, one frame period is divided into a plurality of sub-frame periods having different times according to weighting factors respectively pre-assigned to each bit from LSB to MSB of the input binary data. The deflective modulation element is controlled to be the deflection state of the fully ON direction or the fully OFF direction according to the value of a corresponding bit in each of the sub-frame periods. With such a control, the deflection state switches six times (the deflection state switches from the fully OFF direction to the fully ON direction, or vice versa), if binary data, which is input data, is “10101” of 5 bits shown in FIG. 4A (see Transition points of FIG. 4A).

In contrast, FIG. 4B shows an example of PWM control performed with non-binary data in one frame period in an image display device according to a preferred embodiment of the present invention. The SLM has a deflective modulation element for deflecting illuminating light depending on the state of a stationary deflection direction such as a fully ON direction or a fully OFF direction, and also shows an example of control of projected light. The image display device according to this preferred embodiment that receives input binary data and coverts the input binary data into non-binary data. More specifically, data of the highest-order 2 bits in 5-bit input binary data is converted into a bit string of 6 bits. All of these four bits have a weighting factor of 4, and data of the remaining lowest-order 3 bits in the 5-bit binary data is converted into a bit string of 7 bits. All of these seven bits have a weighting factor of 1. Then, one frame period is divided into 13 sub-frame periods composed of 6 sub-frame periods having a time t1, which corresponds to the weighting factor of 4, and 7 sub-frame periods having a time t2, which corresponds to the weighting factor of 1. According to the weighting factors of the bits of the non-binary data, the deflective modulation element is controlled to operate with the deflection state of the continuing fully ON direction or fully OFF direction according to the value of a corresponding bit in the non-binary data in each of the sub-frame periods. With such a control, the number of time periods of deflection state switching is 4 in the image display device according to this preferred embodiment, and can be made smaller than that of the conventional image display device shown in FIG. 4A.

FIG. 4C shows another example of PWM control performed with non-binary data in one frame period in an image display device according to a preferred embodiment of the present invention. The SLM includes the deflective modulation element for deflecting illuminating light depending on the state of a stationary deflection direction such as the fully ON direction or the fully OFF direction, and also shows another example of control of projected light. Also with the image display device according to this preferred embodiment, that receives the input binary data and converts into non-binary data. More specifically, binary data of 5 consecutive bits, which is input data, is converted into a bit string where the weighting factors of all of bits are equal (not shown). For example, the binary data is converted into a bit string where the weighting factors of all of bits are 1. Then, one frame period is divided into a plurality of sub-frame periods according to the weighting factors of the bits of the non-binary data, and the deflective modulation element is controlled to operate with the deflection state of the continuing fully ON direction or fully OFF direction according to the value of a corresponding bit in the non-binary data in each of the sub-frame periods. In the image display device according to this preferred embodiment for controlling the deflective element as shown, the number of times of deflection state switching is 2 (see Transition points of FIG. 4C), and can be made smaller than that of the conventional image display device shown in FIG. 4A.

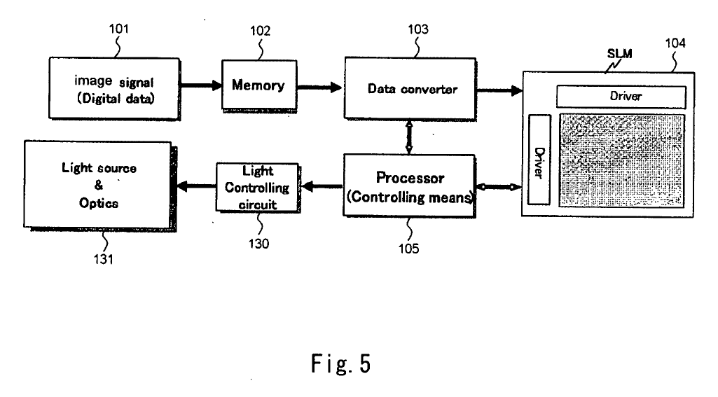

Referring to FIG. 5 for a control block diagram for illustrating a method to control illumination. In addition to the above described image display device according to the preferred embodiment of the present invention can be also configured to further comprise a light source controlling unit for controlling the light amount, the light emission cycle, or the light emission state such as an intensity distribution, etc. of the illuminating light. With the image display device having such a configuration, the amount of projected light can be controlled to have finer scales when the deflection state of the deflective modulation element is the oscillating state or the state of the intermediate direction. Thereby, it is feasible to implement higher gray scale in the same deflective modulation element.

FIG. 5 shows an exemplary system configuration of the image display device implemented with such a configuration. The exemplary system configuration shown in FIG. 5 is a configuration implemented by adding a light source controlling circuit 130, and a light source/optical system 131 to the system configuration example shown in FIG. 3A. The light source controlling circuit 130 controls the light amount, the light emission cycle, or the light emission state such as an intensity distribution, etc. of illuminating light irradiated from the light source.

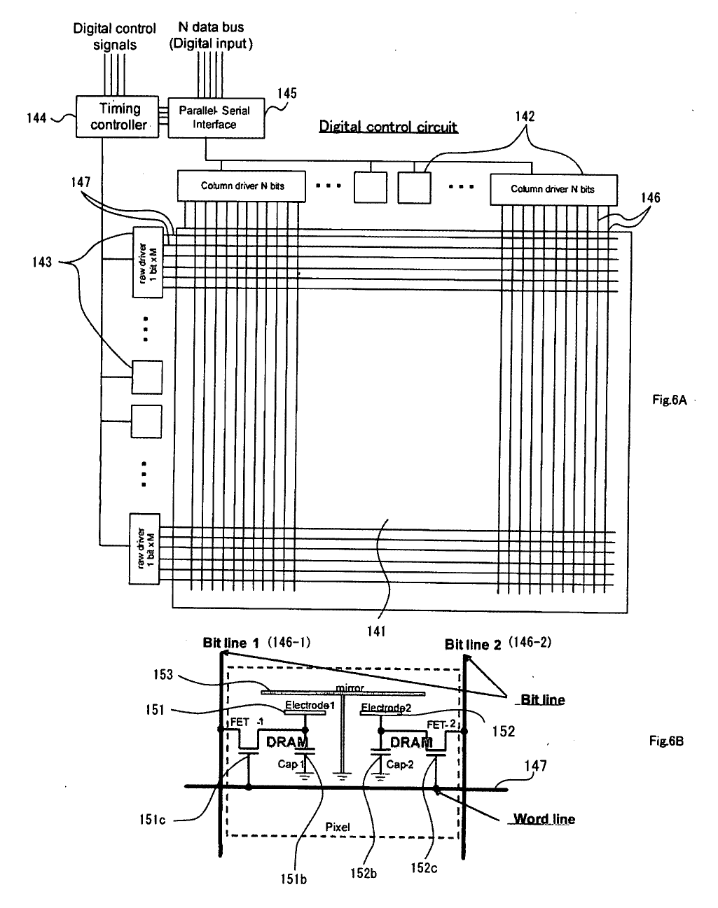

Referring to FIG. 6A for a functional block diagram of a SLM and FIG. 6B for a control circuit diagram that executes a Digital Signal Control scheme. In addition to the above described image display device according to the preferred embodiment of the present invention, the controlling unit can be also configured to control the deflective modulation element with a digital control signal. With the image display device having such a configuration, the oscillating state can be controlled by using non-binary data as a digital signal that is unchanged without converting the digital signal into an analog signal with a D/A converter, etc. Performing the control by using the unchanged non-binary data, as a digital signal is preferable also from a viewpoint that such system do not require to include the D/A converters. The number of signal input lines is equal to the number of bit lines (see FIG. 6B). The system configuration is preferable when an increase of the pixel size of the deflective modulation element is not practical.

FIG. 6A is a conceptual schematic for showing an exemplary layout of the internal configuration of the SLM implemented in an image display device. In FIG. 6A, the SLM 104) comprises a mirror element array 141, which is a deflective modulation element array. The display system further includes column drivers 142, row drivers 143, a timing controller 144, and a parallel/serial interface 145. The timing controller 144 controls the row drivers 143 based on a digital control signal (the digital control signal, for example, from the processor 105). The parallel/serial interface 145 puts a digital signal (the digital signal coming, for example, from the data converter 103), which comes as a parallel signal, into a serial signal, and feeds the signal to the column drivers 142. In the mirror element array 141, a plurality of mirror elements are arranged in the form of a lattice in positions where a bit line 146. The bit line extends from the column driver 142 in a vertical direction, and a word line 147 extends from the row driver 143 in the horizontal direction intersecting the bit lines.

FIG. 6B is a conceptual schematic showing an exemplary configuration of mirror elements arranged in the form of a lattice in the SLM. In FIG. 6B, an OFF capacitor 151b is connected to an OFF electrode 151 (corresponding, for example, to the OFF electrode 115 of FIG.3B), and also connected to a bit line 146-1 and a word line 147 via a gate transistor 151c. Additionally, an ON capacitor 152b is connected to an ON electrode 152 (corresponding, for example, to the ON electrode 116 of FIG. 3B), and also connected to a bit line 146-2 and the word line 147 via a gate transistor 152c. The opening/closing, i.e., an ON-OFF state, of the gate transistors 151c and 152c is controlled by the word line 147. Namely, consecutive mirror elements in a row in an arbitrary word line 147 are simultaneously selected, and the charge/discharge of the OFF capacitor 151b and the ON capacitor 152b is controlled by the bit lines 146-1 and 146-2, whereby the ON/OFF of the mirror 153 in each of the mirror elements in the row is individually controlled. In the above described image display device according to the preferred embodiment of the present invention, the non-binary data is also configured as the decimal data. Additionally, in the above described image display device the weighting factor of the least significant bit of binary data of at least N consecutive bits, which is converted into non-binary data, can be configured to be equal to the weighting factor of the smallest bit of the non-binary data. Specifically, in order to make the display period of the least significant bit of the binary data of N bits that is equal to the smallest display period of the non-binary data. For instance, this is shown in the example of FIG. 4B.

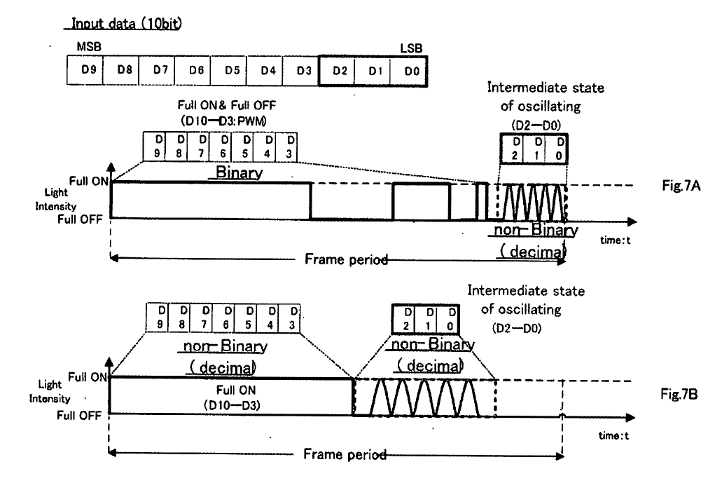

Referring to FIGS. 7A and 7B for another preferred embodiment wherein the N bits are the number of difference between the number of bits of incoming image signal and the number of bits to display in gray scale. When the number of input bits of an image signal is different from that of display gray scales, the above described image display device can also be configured to implement at least N consecutive bits of binary data. The binary data is converted into non-binary data for application to control the state of the deflection direction of the deflective modulation element to operate in the oscillating state. The number of bits of a difference between the number of input bits of the image signal and the number of bits of the display gray scales is configured to include the number of bits of the difference.

FIG. 7A is a diagram for showing an exemplary control of a projected light in one frame period for an image display device. The number of input bits of an image signal and the number of bits of display gray scales are 10 and 7 respectively. The number of bits of their difference is 3 and in this case at least 3 consecutive bits of the input binary data are converted into non-binary data. The non-binary data is used for controlling the state of the deflection direction of the deflective modulation element to operate in an oscillating state. Additionally, the remaining bits of the input binary data not converted into the non-binary data are left unchanged. FIG. 7A shows an exemplary embodiment where the lowest-order 3 bits of the input binary data are converted into non-binary data, and the remaining 7 bits are left unchanged. Then, the state of the deflection direction of the deflective modulation element is controlled to operated in either at a state of the fully ON direction or at a state of a fully OFF direction according to the values of the bits left unchanged and also depending on the weighting factors pre-assigned to these bits. Meanwhile, the modulated deflective elements are controlled to operated in the oscillating state according to the converted non-binary data, whereby projected light in one frame period is totally controlled. In one exemplary embodiment, the converter converts the non-binary data into decimal data.

FIG. 7B is a diagram for showing another exemplary control by applying the difference of the number of bits between the number of input bits of an image signal and the number of bits of display gray scales. The difference in the number of bits is 3 that is similar to the example shown in FIG. 7A. In this example, the entire input binary data is converted into non-binary data to control the deflection state of the deflective modulation element. Note that the state of the deflection direction of the deflective modulation element is controlled to operate in the state of the fully ON direction according to the non-binary data converted from the highest-order 7 bits of the input binary data. The modulated deflective elements are controlled to operate in the oscillating state according to non-binary data converted from the lowest-order 3 bits of the input binary data. In an exemplary embodiment, the non-binary data is converted into decimal data.

In additional to the innovative features disclosed in the above described image display device, alternate exemplary embodiments of the present invention may also include the application of non-uniform light intensity distribution of the illuminating light. Furthermore, alternate preferred embodiments of the present invention might also include display systems by applying the non-binary data for controlling the light amount or the intensity distribution of the illuminating light.

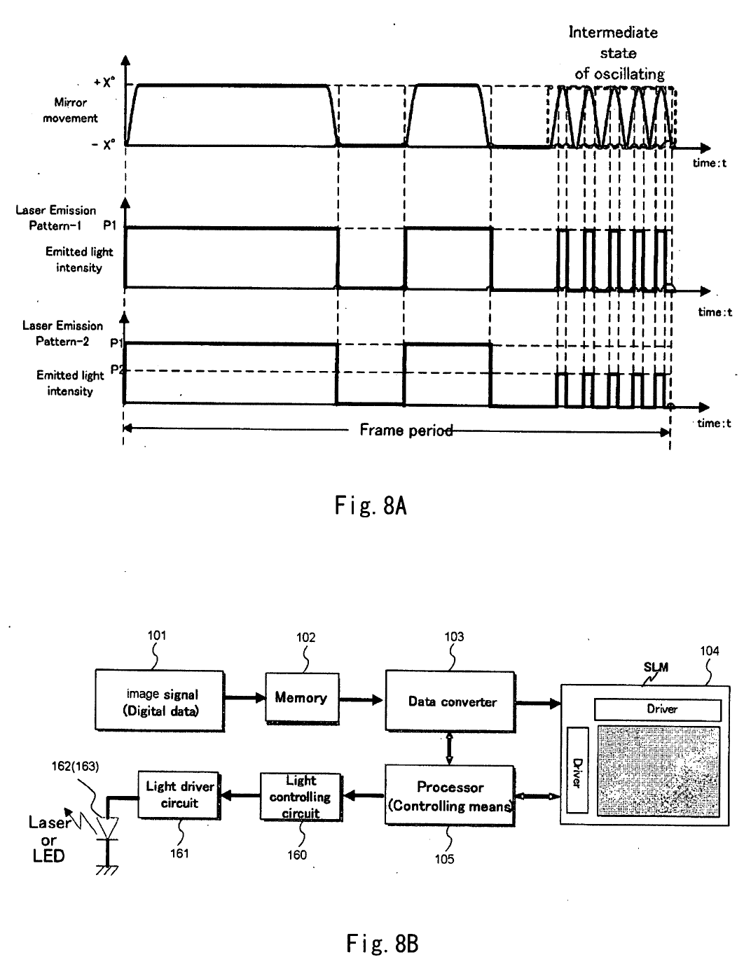

Referring to FIG. 8A for a pulse width diagram of a control signal for a SLM with corresponding light intensity in a frame period. FIG. 8B shows a control circuit diagram that implements an illuminating light projected from a semiconductor laser source or a LED light source.

According to the disclosures made in FIG. 8B, the above described image display device of the present invention may also implement a semiconductor laser light source, or an LED light as the light source.

FIG. 8A is a diagram for showing an exemplary control of the projected light in one frame period of an image display device. FIG. 8A is a functional block diagram for showing an exemplary embodiment for operating a mirror element implemented as a deflective modulation element. A light is projected from a semiconductor laser light source and part of input binary data is converted into non-binary data with the remaining binary data unchanged and remaining according to the original binary data. FIG. 8A shows the deflection state of the mirror element is controlled to operate in the state of the fully ON direction (+X°) or the fully OFF direction (−X°) according to the remaining binary data bits The modulated deflective elements of the SLM are controlled to operate in the oscillating state (+X°˜−X°) according to the non-binary data. Additionally, FIG. 8A further illustrates that the amount of output light and the light emission time of the semiconductor laser light source are controlled in parallel and in addition to the adjustment and control of the deflection state of the mirror element. The light emission pattern shown in FIG. 8A further illustrates that the amount of output light when the mirror element is controlled to operate in the oscillating state is smaller than the light emission pattern in the middle stage of FIG. 8A.

FIG. 8B is a functional block diagram for showing an exemplary system configuration of the image display device, implemented by adding a light source controlling circuit 160, a light source driving circuit 161, and a semiconductor laser light source 162 or an LED light source 163 to the system shown in FIG. 3A. The light source controlling circuit 160 controls the light source driving circuit 161 under the control of the processor 105. The light source driving circuit 161 drives the semiconductor laser light source 162 or the LED light source 163to serve as the light source under the control of the light source controlling circuit 160. With such a configuration, the mirror element and the light emission patterns are controllable to carry out time and amplitude modulated display as that shown in FIG. 8A.

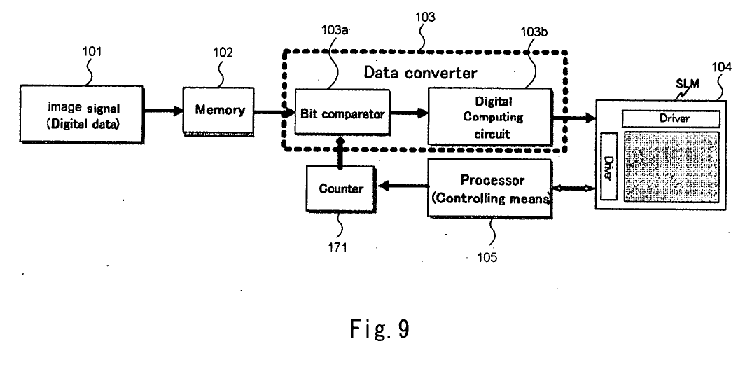

FIG. 9 is functional block diagram for a digital circuit to carry out a process to achieve the non-binary data conversion function.

According the disclosures made in FIG. 9, the above described image display device may have alternate embodiment that include data converting unit implemented by a digital circuit.

FIG. 9 shows an exemplary mage display device implemented with an added counter 171 to the image display system shown in FIG. 3A. Furthermore, the data converter 103 comprises a bit comparator 103a and a digital computing circuit 103b as additional digital circuits. The counter 171 performs a count operation under the control of the processor 105. The bit comparator 103a makes a comparison between input binary data and the count value of the counter 171 to generate output data based on the result of the comparison between the digital computing circuit 103b as a digital signal of “H (1)” or “L (0)”. The digital computing circuit 103b generates non-binary data from the result of the comparison made by the bit comparator 103a by carrying out a digital computation process to generate the output data.

In addition to the above described image display device, the data converting unit can be also configured to have a correction function of an image signal, and to convert the image signal into non-binary data and a correction made on the converted data may be applied. The correction function may include a function to make a y removal or a y correction of the image signal. Or, the correction function may include a function to correct the intensity or the intensity distribution of light modulated by the deflective modulation element. Or, the correction function may further include a function to make visual corrections of an image signal, such as a quantified amount of error in the image signal process, an error of opto-electric conversion introduced by the deflective modulation element, the uniformity error and the false contour of illuminating light, dithering, errors introduced due to IP conversion (Interlace Progressive conversion), scaling, a dynamic range change, etc.

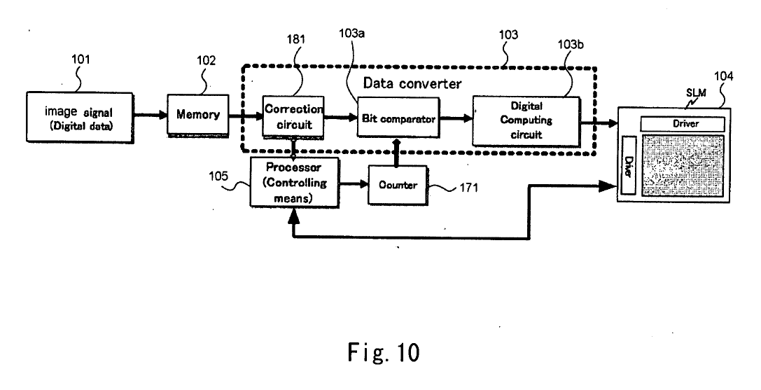

FIG. 10 is a functional block diagram for showing an image display device implemented with a data converter 103 that further includes a correction circuit 181 in addition to the circuit shown in FIG. 9. The correction circuit 181 makes different types of corrections to the binary data as listed above. The corrections may be applied to the input data, under the control of the processor 105, and to the output data for correcting the binary data to the bit comparator 103a in a succeeding stage.

Therefore, in the above described image display device according to the preferred embodiment of the present invention, the data converting unit can be also configured to have a gray scale conversion function to improve the gray scale of binary data. Here, the gray scale conversion function is, for example, a function to convert 8-bit binary data into 10-bit binary data.

In the above described image display device according to the preferred embodiment of the present invention, non-binary data, which is converted by the data-converting unit, can be also configured to transfer directly to the SLM, or transfer to the SLM via a memory. If the non-binary data is transferred via a memory, it is preferable that the memory has a capacity equivalent to the number or more of deflective modulation elements as that included in the SLM and involved in the modulation of the illuminating light.

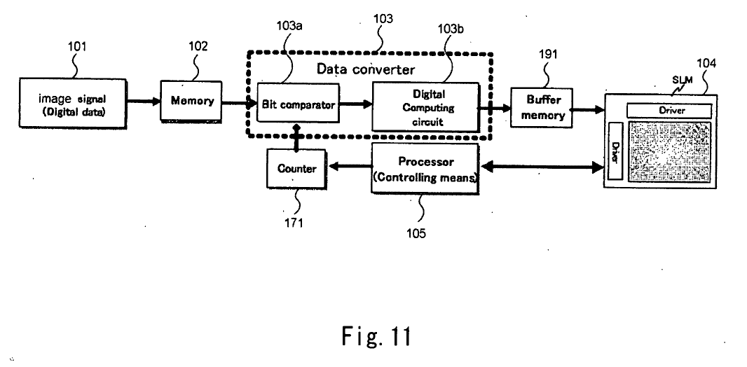

FIG. 11 is a functional block diagram for showing an image display device configured to transfer non-binary data via a memory. The exemplary system configuration includes a buffer memory 191 between the data converter 103 and the SLM 104. The non-binary data converted by the data converter 103 is transferred to the SLM 104 via the buffer memory 191. It is preferable that the buffer memory 191 has a capacity equivalent to the number or more of deflective modulation elements as that included in the SLM 104 and involved in the modulation of the illuminating light. The capacity of the buffer memory 191 can be reduced with optimization according to the processing speed of the data converter 103, and the display rate of the SLM 104.

In the above described image display device according to the preferred embodiment of the present invention, the controlling unit can be also configured to feed a mode signal for determining the deflection state of the deflective modulation element to the SLM.

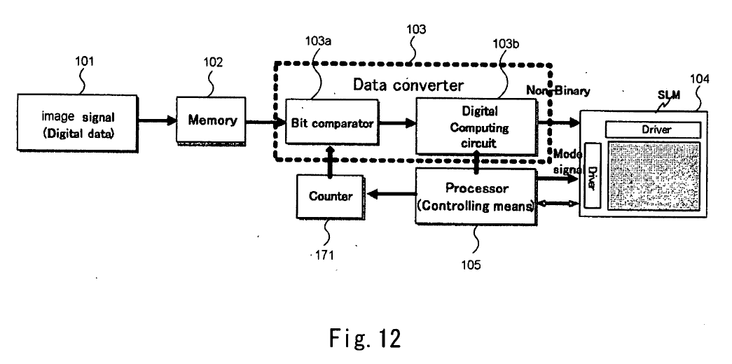

FIG. 12 is a functional block diagram for an image display device wherein the processor 105 feeds the mode signal for determining the deflection state of the deflective modulation element to the SLM 104 in a display system shown in FIG. 9. The deflection state of the deflective modulation element is controlled according to the mode signal, and non-binary data converted by the data converter 103 of the SLM 104. As a result, either of the data transferred to the ON capacitor 152b and the OFF capacitor 151b of each mirror element in the SLM 104 is fed from the data converter 103 to the SLM 104. The deflection state of the deflective modulation element is controlled with reduced amount of fed data.

The above described image display device according to a preferred embodiment of the present invention can be also configured as a single-panel image display device comprising one SLM, or alternately as a multi-panel image display device comprising a plurality of SLMs.

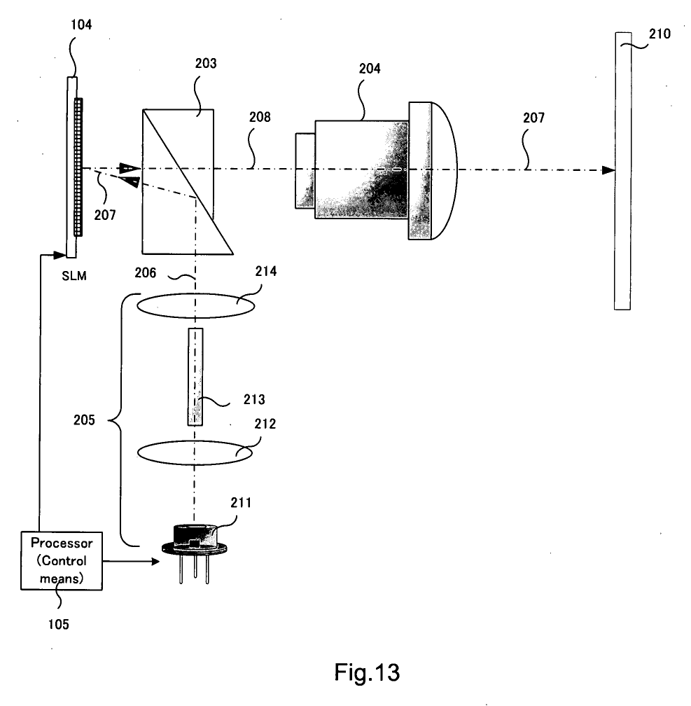

FIG. 13 is a functional block diagram for showing an optical configuration example of a single-panel image display device that comprises one SLM 104, a processor 105, a TIR (Total Internal Reflection) prism 203, a projection optical system 204, and a light source optical system 205. The SLM 104 and the TIR prism 203 are arranged on the optical axis of the projection optical system 204, and the light source optical system 205 is arranged so that its optical axis becomes orthogonal to that of the projection optical system 204. The TIR prism 203 carries out a special function to make the illuminating light 206, incident from the light source optical system 205 at the side to the SLM 104 at a predetermined tilt angle (incident light 207) to generate a reflect light 208 vertically reflected by the SLM 104 to pass through and reach the projection optical system 204. The projection optical system 204 projects the reflection light 208 reflected from the SLM 104 and the TIR prism 203, on a screen 210 as projected light 209. The light source optical system 205 includes a variable light source 211 for generating the illuminating light 206, a condenser lens 212 for concentrating the illuminating light 206, a rod integrator 213, and a condenser lens 214. The variable light source 211, the condenser lens 212, the rod integrator 213, and the condenser lens 214 are arranged on the optical axis of the illuminating light 206 that is output from the variable light source 211 and incident to the side of the TIR prism 203.

In the exemplary optical configuration shown in FIG. 13, a color display on the screen 210 can be made with a color sequential method by using one SLM 104. In this case, the variable light source 211 is configured with a red laser light source, a green laser light source, and a blue laser light source the light emission states. Each of these states can be independently controlled, thus divides one frame of display data into a plurality of sub-fields (3 sub-fields respectively corresponding to R (Red), G (Green), and B (Blue) in this case), and the color lights of red, green, and blue laser light sources in the time series according to the time durations corresponding to the sub-fields of the respective colors.

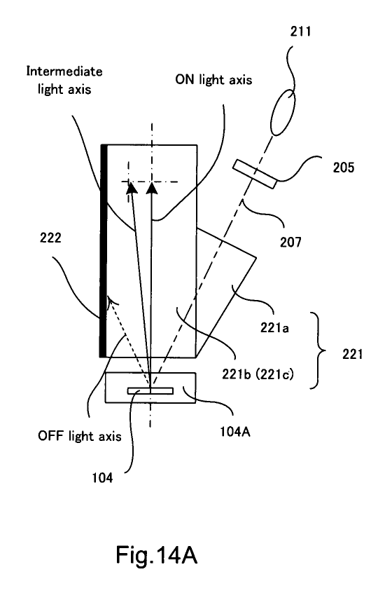

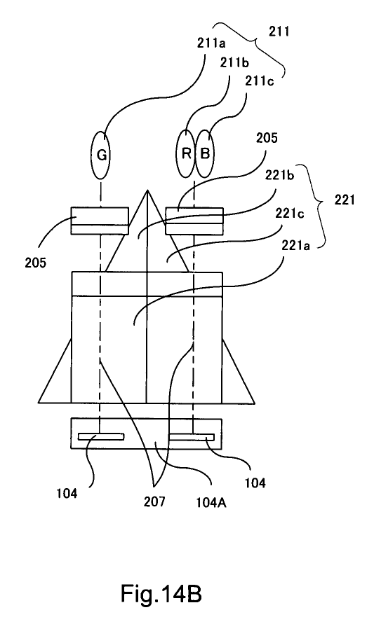

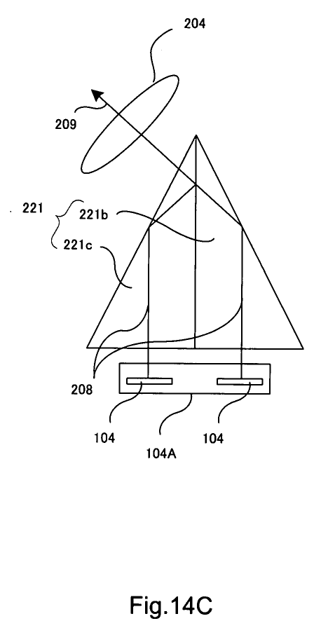

FIGS. 14A, 14B, and 14C show an exemplary optical configuration of a two-panel image display device wherein FIG. 14A is its side view, FIG. 14B is its front view, and FIG. 14C is its rear view. In FIGS. 14A, 14B, and 14C, the same constituent optical elements are included as those shown in FIG. 13 are denoted with the same reference numerals. However, the variable light source 211 is depicted independently as the light source optical system 205 in this exemplary embodiment.

The optical configuration example shown in FIGS. 14A, 14B, and 14C includes a device package 104A where two SLMs 104 are mounted together and the image display device further includes a color synthesis optical system 221, a light source optical system 205, and a variable light source 211. The two SLMs mounted in the device package 104A are fixed so that their rectangular outlines tilt almost at 45 degrees on a horizontal plane with reference to each side of the device package 104A also having a rectangular outline. Above the device package 104A, the color synthesis optical system 221 is arranged. The color synthesis optical system 221 includes prisms 221b and 221c of right-angled triangle poles, which are joined to form almost an equilateral triangular pole on long side faces, and an optical guide block 221a of a right-angled triangle pole, the oblique faces of which are joined with its bottom upwardly oriented, on the side faces of the prisms 221b and 221c. In the prisms 221b and 221c, a light absorber 222 is provided on a side opposite to the face on which the optical guide block 221a is joined. On the bottom of the optical guide block 221a, a light source optical system 205 of a green laser light source 211a, and a light source optical system 205 of a red laser light source 211b and a blue laser light source 211c are provided with their optical axes made vertical. Illuminating light output from the green laser light source 211a is incident, as incident light 207, to one of the SLMs 104, which is positioned immediately below the prism 221b, via the optical guide block 221a and the prism 221b. In the meantime, illuminating lights output from the red laser light source 221b and the blue laser light source 211c are incident, as incident lights 207, to the other SLM 104, which is positioned immediately below the prism 221c, via the optical guide block 221a and the prism 221c. The red and the blue incident lights 207 incident to the SLM 104 are reflected within the prism 221c vertically upward as reflection light 208 and further reflected from the outer side of the prism 221c and the joining face according to this order and incident to the projection optical system 204, thus resulting in a projected light 209, when the deflection state of the deflective modulation element is modulated to a fully ON state. In contrast, the green incident light 207 incident to the SLM 104 is reflected within the prism 221b vertically upward as reflection light 208, further reflected on the outer side of the prism 221b, incident to the projection optical system 204 by tracking the same optical path as the green and the blue reflection light 208, and results in the projection light 209, when the deflection state of the deflective modulation element is modulated to a fully ON state.

As described above, in the exemplary optical configurations shown in FIGS. 14A, 14B, and 14C, only the incident light 207 from the green laser light source 211a is irradiated to one of the SLMs 104 included in the device package 104A, and the incident light 207 from at least either of the red laser light source 211b and the blue laser slight source 211c is irradiated to the other SLM 104. The lights are respectively modulated by the two SLMs 104 and projected only within the color synthesis optical system 221, enlarged by the projection optical system 204, and projected onto a screen as the projected light 209 described above to display a color image.

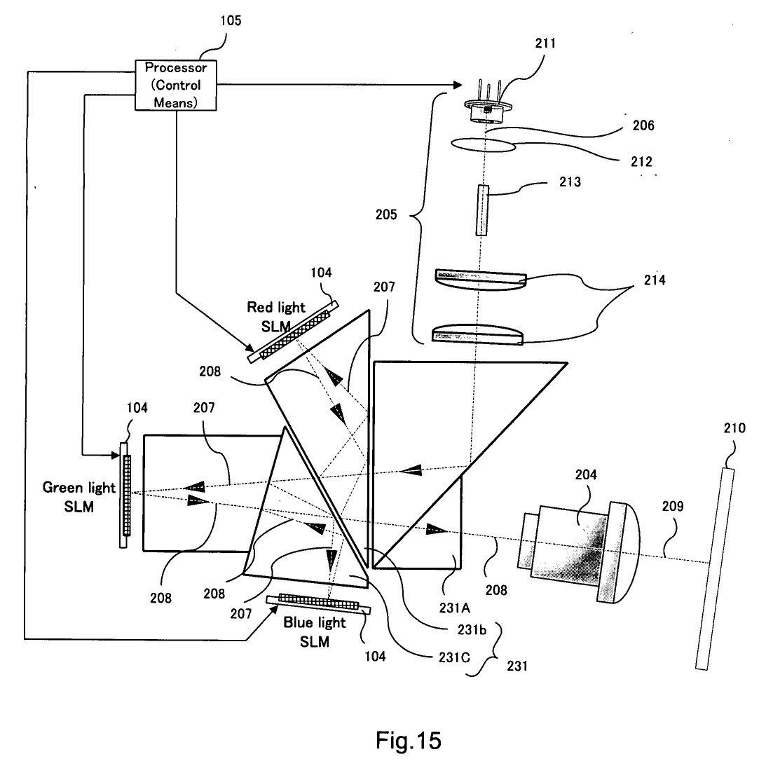

FIG. 15 is a functional block diagram for showing an exemplary optical configuration of a three-panel image display device having same constituent elements as those shown in FIG. 13 are denoted with the same reference numerals. The 3-panel image display device according to this preferred embodiment comprises 3 SLMs 104, and a light separation/synthesis optical system 231 is arranged between a projection optical system 204 and each of the 3 SLMs 104. The light separation/synthesis optical system 231 is constructed by use of 3 TIR prisms 231a, 231b, and 231c. The TIR prism 231a performs the functions to guide illuminating light 206 incidents from the side face of the optical axis of the projection optical system 204 and to the side of the SLM 104 as incident light 207. The TIR prism 231b performs the functions to separate red (R) light from the incident light 207 coming via the TIR prism 231a, to make the separated light incident to the SLM 104 for red color, and to guide its reflection light 208 to the TIR prism 231a. Similarly, the TIR prism 231c performs the functions to separate blue (B) and green (G) lights from the incident light 207 coming via the TIR prism 213a, to make the separated lights incident to the SLMs 104 for blue and green colors, and to guide their reflection lights 208 to the TIR prism 231a. Accordingly, the spatial light modulations for the three colors such as R, G, and B carried out the light modulation function simultaneously, and the reflection lights 208 resultant from the modulations become projected light 209 via the projection optical system 204, and projected on the screen 210 to display a color image.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

1. An image projection device receiving a light from a light source through an illumination optic for projecting to a spatial light modulator (SLM) having a plurality of deflectable micromirrors wherein said micromirrors further comprising:
a controller includes a converter for receiving and converting several bits of an input binary data into non-binary data for controlling said micromirrors of said SLM to operate at an intermediate state.

2. The image projection device of claim 1 wherein:
said controller further applying said non-binary data for controlling said micromirrors of said SLM to operate at an oscillating state.

3. The image projection device of claim 1 wherein:
said converter further converting said input binary data into a decimal data as said non-binary data.

4. The image projection device of claim 1 wherein:
said controller further applying a weighting factor of a least significant bit of said binary data for converting said binary data into said non-binary data.

5. The image projection device of claim 1 wherein:
said controller further applying a weighting factor of a least significant bit of said binary data for converting said binary data into said non-binary data and applying said non-binary data to pulse-width modulating said SLM for operating said micromirrors with additional scales of image-display brightness.

6. The image projection device of claim 1 wherein:
said converter further includes a correction function for carrying out an image data correction on said non-binary data generate by said converter.

7. The image projection device of claim 1 wherein:
said converter further includes a correction function for carrying out an image data correction by making a γ removal or a γ correction on said non-binary data generate by said converter.

8. The image display device of claim 1, wherein:
said converter further feeds to said SLM a mode signal for determining a deflection state of said micromirrors.

9. The image display device of claim 1, further comprising
a light source controller unit controlling said light source to project an illumination light with a light emission cycle according to a light emission state for further increasing a flexibility to control a gray scale of image display.

10. An image projection device receiving a light from a light source through an illumination optic for projecting to a spatial light modulator (SLM) having a plurality of deflectable micromirrors wherein said micromirrors further comprising:
a controller includes a converter for receiving and converting several consecutive bits of an input binary data into non-binary data for controlling said micromirrors of said SLM to operate at an intermediate state wherein said intermediate state is maintained continuously over a predefined length of time.

11. The image projection device of claim 10 wherein:
said controller further applying some binary bits of said input binary data for controlling said micromirrors to operate at a fully-ON and a fully-ON state.

12. The image projection device of claim 10 wherein:
said converter further converting said several consecutive bits of said input binary data into a decimal data.

13. The image projection device of claim 10 wherein:
said controller further applying a weighting factor of a least significant bit of said several consecutive binary bits of said binary data for converting said binary data into said non-binary data.

14. The image projection device of claim 10 wherein:
said converter further includes a correction function for carrying out an image data correction on image data generated by said SLM controlled by said non-binary data.

15. The image projection device of claim 10 wherein:
said converter further includes a correction function for carrying out an image data correction by making a γ removal or a γ correction on image data generated by said SLM controlled by said non-binary data.

16. The image projection device of claim 10 wherein:
said converter further includes a correction function for carrying out an intensity of intensity distribution correction on image data generated by said SLM controlled by said non-binary data.

17. The image display device of claim 10 wherein:
said converter further feeds to said SLM a mode signal for determining a deflection state of said micromirrors.

18. The image display device of claim 10, further comprising
a light source controller unit controlling said light source to project an illumination light with a light emission cycle according to a light emission state for further increasing a flexibility to control a gray scale of image display.
